(19) United States
(12) Patent Application Publication
(10) Pub. No.: US 2018/0373522 A1
(43) Pub. Date: Dec. 27, 2018

(54) IN-VEHICLE UPDATING DEVICE, UPDATING SYSTEM, AND UPDATE PROCESSING PROGRAM

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Tsuyoshi Kontani, Yokkaichi, Mie (JP); Shinya Itou, Yokkaichi, Mie (JP)

(21) Appl. No.: 15/777,834

(22) PCT Filed: Dec. 26, 2016
(86) PCT No.: PCT/JP2016/088755

§ 371 Date: May 21, 2018

(30) Foreign Application Priority Data
Jan. 6, 2016 (JP) 2016-001107

(51) Int. Cl. G06F 8/65; H04L 29/08; H04W 4/48

(52) U.S. Cl. CPC G06F 8/65; H04W 4/48; H04L 67/34

(57) ABSTRACT

Provided are an in-vehicle updating device, an updating system and an update processing program that are able to efficiently perform update processing of an in-vehicle communication device connected to a plurality of communication lines. Update processing of an ECU connected to communication lines is performed, by a gateway transmitting repro data for use in updating to the ECU. A repro tool stores divided data of the repro data, and transmits the divided data to the gateway. The repro tool attaches, to the plurality of divided data, sequential order information for use in restoring the divided data, and transmits the resultant data to the gateway. The gateway determines a communication state of each communication line, appropriately distributes the plurality of divided data to the plurality of communication lines, according to the determined communication states, and transmits the plurality of divided data to the ECU via the plurality of communication lines.

### CROSS-REFERENCE TO RELATED APPLICATIONS

This application is the US national stage of PCT/JP2016/088755 filed Dec. 26, 2016 which claims priority of Japanese Application No. JP 2016-001107 filed Jan. 6, 2016.

### TECHNICAL FIELD

The present invention relates to an in-vehicle updating device, an updating system and an update processing program that perform update processing of an in-vehicle communication device, by transmitting a program or data for use in updating to the in-vehicle communication device.

### BACKGROUND ART

Conventionally, in-vehicle communication devices such as a plurality of ECUs (Electronic Control Units) are mounted in a vehicle, and the plurality of ECUs are configured to be capable of transmitting and receiving information amongst each other by being connected via a communication line such as a CAN (Controller Area Network) bus. Each ECU performs various processing such as controlling the vehicle, by a processing device such as a CPU (Central Processing Unit) reading out and executing programs stored in a storage unit such as a flash memory or an EEPROM (Electrically Erasable Programmable Read-Only Memory). Update processing for rewriting programs or data stored in the storage unit of an ECU to new programs or data needs to be performed, when the need arises to add functions, repair malfunctions, upgrade or the like, for example. In this case, programs or data for use in updating are transmitted via a communication line to the ECU that is to undergo update processing.

In JP 2014-194688A, a configuration is provided in which a rewriting device and a plurality of ECUs to be rewritten are connected with the same network bus, and a program rewriting method is proposed in which the rewriting device transmits data simultaneously to all of the ECUs to be rewritten using a specific ID determined in advance, and the ECUs to be rewritten generate respectively different IDs using individual identification data, and transmit data to the rewriting device using the generated IDs.

In recent years, with regard to ECUs which serve an important function in a vehicle, attempts have been made to improve the reliability of vehicles, by connecting the ECUs to a plurality of communication lines. For example, since an ECU connected to two communication lines can communicate via the other communication line, even if one of the communication lines becomes unusable for some reason, it is possible to prevent a situation in which the function served by this ECU cannot be utilized.

With regard to such ECUs connected to a plurality of communication lines, consideration has not yet been given to how update processing of programs or data will be performed.

The present invention was made in view of such a situation, and an object thereof is to provide an in-vehicle updating device, an updating system and an update processing program that are able to efficiently perform update processing of an in-vehicle communication device connected to a plurality of communication lines.

### SUMMARY

An in-vehicle updating device according to the present invention is an in-vehicle updating device configured to be connected to an in-vehicle communication device via at least two communication lines and to perform processing for updating a program or data stored in a storage unit of the in-vehicle communication device, the in-vehicle updating device including a storage unit configured to store a plurality of divided data for use in updating into which a program or data for use in updating that is to be transmitted to the in-vehicle communication device has been divided, a communication state determination unit configured to determine a communication state of each of the communication lines, and a transmission processing unit configured to perform processing for distributively transmitting the plurality of divided data for use in updating stored in the storage unit to the in-vehicle communication device via the at least two communication lines, according to a determination result of the communication state determination unit.

Also, in the in-vehicle updating device according to the present invention, the communication state determination unit determines a communication load of each of the communication lines, and the transmission processing unit distributes the plurality of divided data for use in updating to the at least two communication lines according to the communication loads.

Also, the in-vehicle updating device according to the present invention further includes a communication unit configured to communicate with a storage device storing the divided data for use in updating, and a storage processing unit configured to perform processing for storing the divided data for use in updating received from the storage device via the communication unit in the storage unit.

An updating system according to the present invention is an updating system including an in-vehicle communication device that is connected to at least two communication lines and has a first storage unit configured to store a program or data, and an in-vehicle updating device that is connected to the in-vehicle communication device via the at least two communication lines and performs processing for updating the program or data stored in the storage unit of the in-vehicle communication device, the in-vehicle updating device including a storage unit configured to store a plurality of divided data for use in updating into which a program or data for use in updating that is to be transmitted to the in-vehicle communication device has been divided, a communication state determination unit configured to determine a communication state of each of the communication lines, and a transmission processing unit configured to perform processing for distributively transmitting the plurality of divided data for use in updating stored in the storage unit to the in-vehicle communication device via the at least two communication lines, according to a determination result of the communication state determination unit.

Also, the updating system according to the present invention further includes a storage device storing the divided data for use in updating, and the in-vehicle updating device further includes a communication unit configured to communicate with the storage device storing the divided data for use in updating, and a storage processing unit configured to perform processing for storing the divided data for use in updating received from the storage device via the communication unit in the storage unit.

Also, in the updating system according to the present invention, the storage device attaches sequential order information to the divided data for use in updating, and transmits the divided data for use in updating to which the sequential order information is attached to the in-vehicle updating device, and the storage processing unit of the in-vehicle updating device stores the divided data for use in updating to which the sequential order information is attached in the storage unit.

Also, in the updating system according to the present invention, the in-vehicle communication device includes a second storage unit configured to temporarily store the divided data for use in updating received from the in-vehicle updating device via the at least two communication lines, and an update processing unit configured to perform processing for updating the program or data stored in the first storage unit, using the divided data for use in updating stored in the second storage unit, based on the sequential order information attached to the divided data for use in updating stored in the second storage unit.

Also, an update processing program according to the present invention causes an in-vehicle updating device configured to be connected to an in-vehicle communication device via at least two communication lines and to perform processing for updating a program or data stored in a storage unit of the in-vehicle communication device to operate as a storage processing unit configured to store a plurality of divided data for use in updating into which a program or data for use in updating that is to be transmitted to the in-vehicle communication device has been divided in a storage unit, a communication state determination unit configured to determine a communication state of each of the communication lines, and a transmission processing unit configured to perform processing for distributively transmitting the plurality of divided data for use in updating stored in the storage unit to the in-vehicle communication device via the at least two communication lines, according to a determination result of the communication state determination unit.

In the present invention, update processing of an in-vehicle communication device connected to at least two communication lines is performed, by an in-vehicle updating device connected to these two communication lines transmitting a program or data for use in updating to the in-vehicle communication device. The in-vehicle updating device stores a plurality of data into which the program or data for use in updating has been divided in a storage unit as divided data for use in updating.

The in-vehicle updating device determines the communication state of each communication line, appropriately distributes the plurality of divided data for use in updating to the plurality of communication lines according to the determined communication states, and transmits the plurality of divided data for use in updating to the in-vehicle communication device via the plurality of communication lines. It thereby becomes possible for the in-vehicle updating device to efficiently perform high speed communication of the plurality of divided data for use in updating to the in-vehicle communication device, by effectively utilizing the plurality of communication lines.

Also, in the present invention, the in-vehicle updating device determines the communication load of each communication line, with regard to the plurality of communication lines to which the in-vehicle communication device to be updated is connected. The in-vehicle updating device is able to perform distribution of the divided data for use in updating that depends on the determined communication loads, such as distributing the divided data for use in updating preferentially to a communication line that has a low load, for example. The in-vehicle updating device is thereby able to efficiently utilize the plurality of communication lines.

Also, in the present invention, a storage device that is separate from the in-vehicle updating device stores the divided data for use in updating. When performing update processing, the divided data for use in updating is transmitted to the in-vehicle updating device from the storage device, and this divided data for use in updating is provided from the in-vehicle updating device to the in-vehicle communication device. The in-vehicle updating device thereby does not need to store the divided data for use in updating, and need only temporarily store the divided data for use in updating provided from the storage device. Note that the in-vehicle updating device and the storage device may perform either wired or wireless communication, and, in the case of wired communication, the storage device may be configured to be removably attached to the in-vehicle updating device via a communication cable or the like.

Also, in the present invention, the storage device attaches, to the divided data for use in updating into which the program or data for use in updating has been divided, sequential order information for restoring the divided data, and transmits the resultant data to the in-vehicle updating device. The in-vehicle updating device, in the case where divided data for use in updating is received from the storage device, stores the divided data for use in updating in the storage unit together with the sequential order information. Also, the in-vehicle updating device transmits the divided data for use in updating to which the sequential order information is attached to the in-vehicle communication device. The in-vehicle communication device that receives the divided data for use in updating via the plurality of communication lines is thereby able to restore the original program or data from the plurality of divided data for use in updating, even in the case where the order of the divided data for use in updating differs from the received order.

Also, in the present invention, the in-vehicle communication device has a second storage unit that temporarily stores the divided data for use in updating received from the in-vehicle updating device via the plurality of communication lines, in addition to a first storage unit that stores programs or data that are used in processing that the in-vehicle communication device itself performs. The in-vehicle communication device performs processing for updating the programs or data stored in the first storage unit, using the divided data for use in updating stored in the second storage unit, based on the sequential order information attached to the divided data for use in updating. Update processing of programs or data can thereby be reliably performed, using divided data for use in updating that is received in random order via a plurality of communication lines.

According to the present invention, by adopting a configuration in which an in-vehicle updating device appropriately distributes a plurality of divided data for use in updating to a plurality of communication lines according to the communication state of each communication line and transmits the divided data for use in updating to an in-vehicle communication device to be updated, high-speed transmission of the divided data for use in updating can be performed through effectively utilizing the plurality of communication lines, thereby enabling update processing of the in-vehicle communication device connected to the plurality of communication lines to be efficiently performed.

### BRIEF DESCRIPTION OF DRAWINGS

FIG. 1 is a schematic diagram showing an exemplary configuration of an updating system according to the present embodiment.

FIG. 2 is a block diagram showing a configuration of an ECU.

FIG. 3 is a block diagram showing a configuration of a gateway.

FIG. 4 is a block diagram showing a configuration of a repro tool.

FIG. 5 is a schematic diagram for illustrating transmission of repro data that is performed by the repro tool.

FIG. 6 is a flowchart showing a procedure of transmission processing of repro data that is performed by the repro tool.

FIG. 7 is a flowchart showing a procedure of reception processing of repro data that is performed by the gateway.

FIG. 8 is a flowchart showing a procedure of transmission processing of repro data that is performed by the gateway.

FIG. 9 is a flowchart showing a procedure of reception processing of repro data that is performed by the ECU.

FIG. 10 is a flowchart showing a procedure of update processing of an application program that is performed by the ECU.

FIG. 11 is a schematic diagram showing an exemplary configuration of an updating system according to a variation.

### DETAILED DESCRIPTION OF PREFERRED EMBODIMENTS

System Configuration

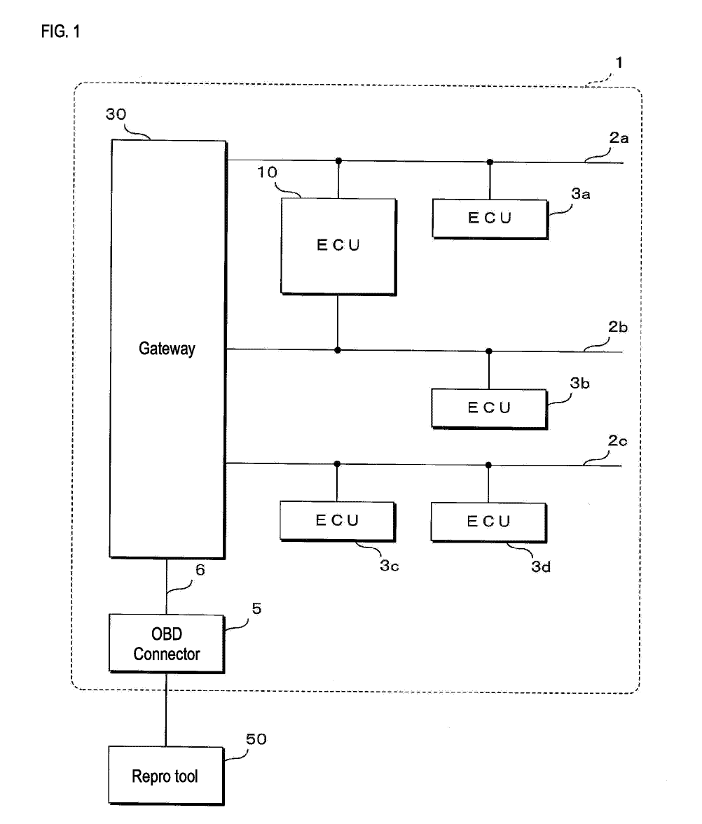

FIG. 1 is a schematic diagram showing an exemplary configuration of an updating system according to the present embodiment. The updating system according to the present embodiment is configured such that, in a communication system in which a plurality of ECUs 3a to 3d and 10 mounted in a vehicle 1 can communicate with each other via communication lines 2a to 2c and a gateway 30, the gateway 30 updates programs or data that are stored in the ECUs 3a to 3d and 10. In the illustrated example, the vehicle 1 includes four ECUs 3a to 3d and one ECU 10. The ECU 3a is connected to the communication line 2a, the ECU 3b is connected to the communication line 2b, and the ECU 3c and 3d are connected to the communication line 2c. The ECUs 3a to 3d are each able to transmit and receive information over the respective one of the communication lines 2a to 2c to which these ECUs are connected. In contrast, the ECU 10 is connected to the two communication lines 2a and 2b, and is able to transmit and receive information over both communication lines 2a and 2b. For example, the ECU 10 is able to use the communication line 2a when communicating with the ECU 3a, and is able to use the communication line 2b when communicating with the ECU 3b.

The communication lines 2a to 2c to which the ECUs 3a to 3d and 10 are connected are each connected to the gateway 30. The gateway 30 is a device that relays communication between the communication lines 2a to 2c. The gateway 30 relays communication by transmitting information received over one of the three communication lines 2a to 2c through the other of the communication lines 2a to 2c. For example, the ECU 3a thereby becomes able to communicate with the ECU 3b via the communication line 2a, the gateway 30 and the communication line 2b.

Also, the gateway 30 is connected to an OBD (On-Board Diagnostics) connector 5 disposed in an appropriate location of the vehicle 1 via a communication line 6. The OBD connector 5 is a connector for an external device to acquire various information through a self-diagnostic function of the vehicle 1. In the present embodiment, by connecting a reprogramming tool (hereinafter, repro tool) 50 provided in a dealer or a repair shop of the vehicle 1, for example, to the OBD connector 5 of the vehicle 1 via a dedicated communication cable, communication can be performed between the gateway 30 and the repro tool 50. The repro tool 50 provides a program or data for use in updating one of the ECUs 3a to 3d and 10 to the gateway 30, the gateway 30 transmits the provided program or data for use in updating to the one of the ECUs 3a to 3d and 10 to be updated, and updating is performed by the one of the ECUs 3a to 3d and 10 that receives the program or data.

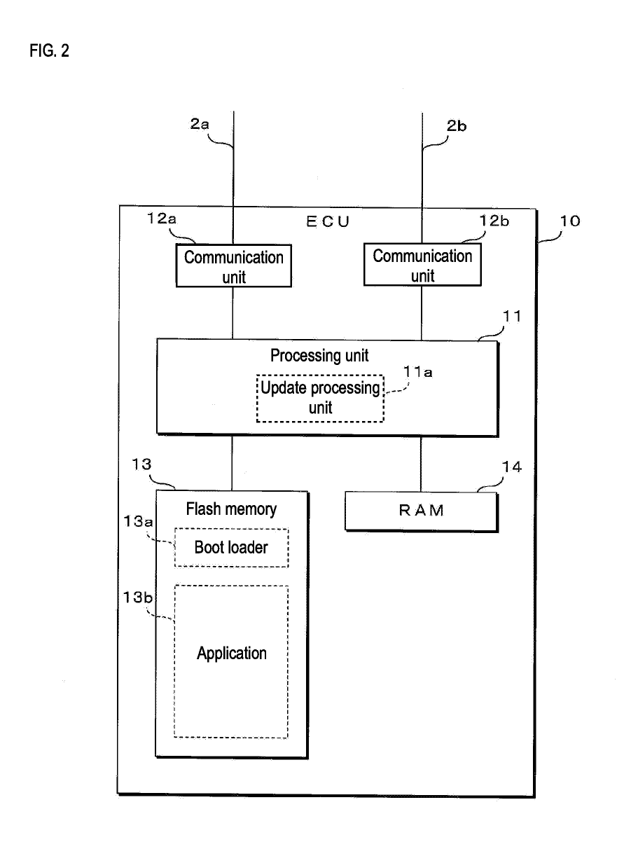

FIG. 2 is a block diagram showing a configuration of the ECU 10. The ECU 10 according to the present embodiment is configured to include a processing unit 11, two communication units 12a and 12b, a flash memory 13, and a RAM (Random Access Memory) 14. The processing unit 11 is constituted using a computational processing device such as a CPU. The processing unit 11 performs control processing of the vehicle 1, various computational processing and the like, by reading out and executing an application program (“application” in the drawings) 13b stored in the flash memory 13. Also, the processing unit 11 performs processing such as initialization of the ECU 10 and updating of the application program 13b, by reading out and executing a boot loader program (“boot loader” in the drawings) 13a stored in the flash memory 13. In the processing unit 11, an update processing unit 11a that performs update processing of the application program 13b is realized as a software-based functional block, by executing the boot loader program 13a.

The ECU 10 according to the present embodiment has the two communication units 12a and 12b, and is able to communicate with the other ECUs 3a to 3d via the two communication lines 2a and 2b. The communication line 2a is connected to the communication unit 12a, and performs communication via the communication line 2a. The communication line 2b is connected to the communication unit 12b, and performs communication via the communication line 2b. The communication units 12a and 12b perform information transmission by converting information for transmission provided from the processing unit 11 into an electrical signal and outputting the electrical signal to the communication lines 2a and 2b, and perform information reception by acquiring the signals of the communication lines 2a and 2b through sampling, and provide the received information to the processing unit 11. The processing unit 11, in the case of performing information transmission, need only appropriately judge which of the communication units 12a and 12b to perform transmission with.

Note that, in the present embodiment, the ECUs 3a to 3d and 10 and the gateway 30 perform communication in accordance with the CAN communication protocol, for example, via the communication lines 2a to 2c. In this case, the communication lines 2a to 2c are so-called CAN buses, and the communication units 12a and 12b can be constituted using CAN controllers.

The flash memory 13 is a data rewritable nonvolatile memory device, and stores programs such as the boot loader program 13a and the application program 13b. Also, although illustration is omitted, data required in executing these programs is stored in the flash memory 13. The processing unit 11 is able to perform various processing, by reading out and executing these programs stored in the flash memory 13. Also, the processing unit 11 is able to erase and write data with respect to the flash memory 13.

The RAM 14 is constituted using a memory device such as a SRAM (Static Random Access Memory) or a DRAM (Dynamic Random Access Memory), for example. The processing unit 11 is able to read out and write data with respect to the RAM 14. The RAM 14, for example, temporarily stores information generated in the process of computational processing that is performed by the processing unit 11. Also, the RAM 14, for example, temporarily stores information received by the communication units 12a and 12b.

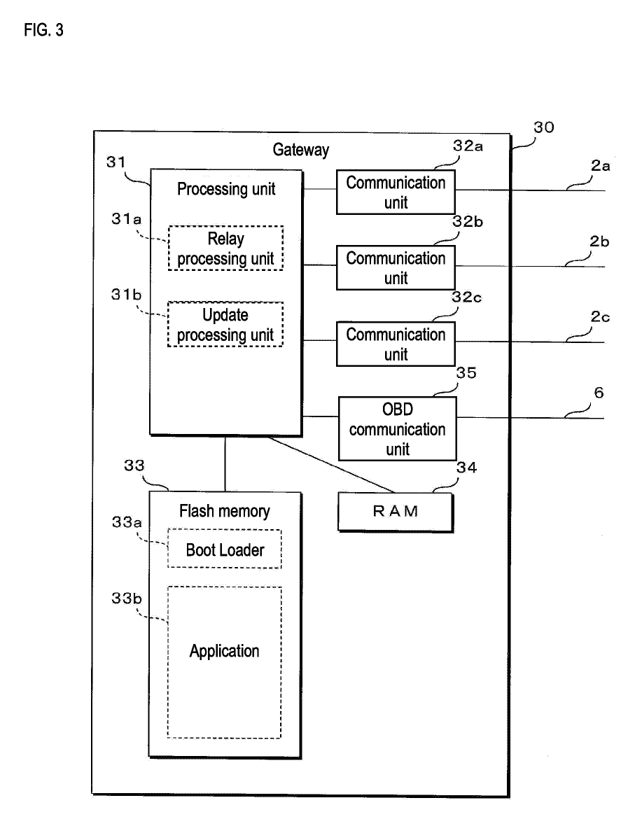

FIG. 3 is a block diagram showing a configuration of the gateway 30. The gateway 30 according to the present embodiment includes a processing unit 31, communication units 32a to 32c, a flash memory 33, a RAM 34, and an OBD communication unit 35. The processing unit 31 is constituted using a computational processing device such as a CPU. The processing unit 31 performs processing such as relaying communication between the communication lines 2a to 2c, and updating the application program 13b of the ECUs 3a to 3d and 10, by reading out and executing an application program 33b stored in the flash memory 33. In the processing unit 31, a relay processing unit 31a that performs processing related to relaying communication and an update processing unit 31b that performs processing related to updating the ECUs 3a to 3d and 10 are realized as software-based functional blocks by executing the application program 33b. Also, the processing unit 31 performs processing such as initializing the gateway 30 and updating the application program 33b, by reading out and executing a boot loader program 33a stored in the flash memory 33.

The gateway 30 has three communication units 32a to 32c, and the communication units 32a to 32c are constituted using CAN controllers, for example. The communication unit 32a is connected to the communication line 2a, and performs communication via the communication line 2a. The communication unit 32b is connected to the communication line 2b, and performs communication via the communication line 2b. The communication unit 32c is connected to the communication line 2c, and performs communication via the communication line 2c. The communication units 32a to 32c perform information transmission by converting information for transmission provided from the processing unit 31 into an electrical signal and outputting the electrical signal to the communication lines 2a to 2c, and perform information reception by acquiring the signals of the communication lines 2a to 2c through sampling, and provide the received information to the processing unit 31. The relay processing unit 31a of the processing unit 31, in the case where information is received with one of the communication units 32a to 32c, relays communication by transmitting this information from the other of the communication units 32a to 32c.

The flash memory 33 is a data rewritable nonvolatile memory device, and stores programs such as the boot loader program 33a and the application program 33b. Also, although illustration is omitted, data required in executing these programs is stored in the flash memory 33. The processing unit 31 is able to perform various processing, by reading out and executing these programs stored in the flash memory 33. Also, the processing unit 31 is able to erase and write data with respect to the flash memory 33.

The RAM 34 is constituted using a memory device such as a SRAM or a DRAM, for example. The processing unit 31 is able to read out and write data with respect to the RAM 34. The RAM 34, for example, temporarily stores information generated in the process of computational processing that is performed by the processing unit 31. Also, the RAM 34, for example, temporarily stores information received by the communication units 32a to 32c. Also, the RAM 34, for example, temporarily stores information received from the repro tool 50 via the OBD connector 5.

The OBD communication unit 35 is connected to the OBD connector 5 via the communication line 6. The OBD communication unit 35 communicates with the repro tool 50 connected to the OBD connector 5. Note that communication between the OBD communication unit 35 of the gateway 30 and the repro tool 50 via the OBD connector 5 may be performed in accordance with the CAN communication protocol or may be performed in accordance with other communication protocols. The OBD communication unit 35 performs information transmission by converting information for transmission provided from the processing unit 31 into an electrical signal and outputting the electrical signal to the communication line 6, and performs information reception by acquiring the signal of the communication line 6 through sampling, and provides the received information to the processing unit 31.

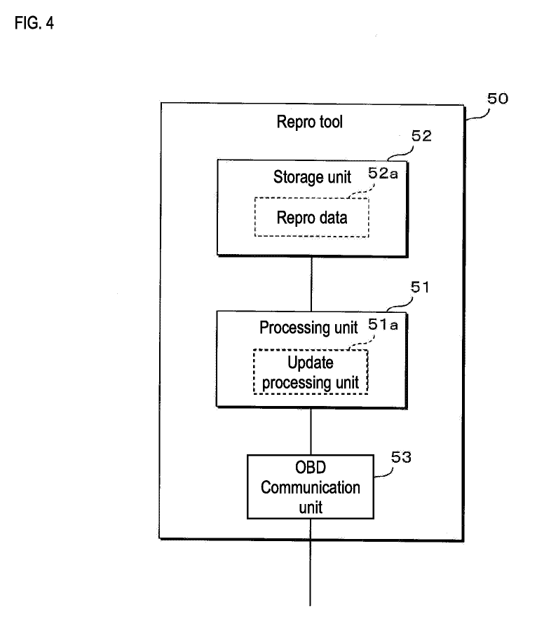

FIG. 4 is a block diagram showing a configuration of the repro tool 50. The repro tool 50 according to the present embodiment is a portable device provided in a dealer or a repair shop of the vehicle 1, for example, and is a device for updating (reprogramming) the application programs 13b and 33b of the ECUs 3a to 3d and 10 of the vehicle 1. A worker, at the time of performing a task on the vehicle 1 such as maintenance work or an inspection, downloads and stores data for use in updating in the repro tool 50 from a server device or the like, and connects the repro tool 50 to the OBD connector 5 of the vehicle 1 via a dedicated communication cable. After performing predetermined processing such as authentication processing, for example, between the repro tool 50 and the gateway 30, the repro tool 50 transmits the downloaded data for use in updating to the gateway 30, and starts updating the application programs 13b and 33b of the ECUs 3a to 3d and 10.

The repro tool 50 is constituted to include a processing unit 51, a storage unit 52, and an OBD communication unit 53. The processing unit 51 is constituted using a computational processing device such as a CPU. The processing unit 51 performs various processing related to updating of the ECUs 3a to 3d and 10, by reading out and executing a program stored in the storage unit 52 or a ROM (Read-Only Memory) which is not illustrated. In the processing unit 51, through execution of the program, an update processing unit 51a that performs update processing of the ECUs 3a to 3d and 10 and 10 is realized as a software-based functional block.

The storage unit 52 may be constituted using a nonvolatile memory device such as a flash memory or an EEPROM, may be constituted using a volatile memory device such as a SRAM or a DRAM, or may be constituted using a magnetic storage device such as a hard disk. The storage unit 52 stores reprogramming data (hereinafter, repro data) 52a to be used in updating the ECUs 3a to 3d and 10. The update processing according to the present embodiment is processing for partially or entirely replacing (overwriting) the application program 13b stored in the flash memory 13 of the ECU 10, for example, with a new application program. The repro data 52a downloaded and stored in the storage unit 52 of the repro tool 50 is the new replacement application program.

The OBD communication unit 53 has a communication cable that is connected to the OBD connector 5 of the vehicle 1. Note that this communication cable may be configured to be detachable from the OBD communication unit 53, or may be configured to be fixed to the OBD communication unit 53. The OBD communication unit 53 communicates with the gateway 30 of the vehicle 1, in a state of being connected to the OBD connector 5 of the vehicle 1 via the communication cable. The OBD communication unit 53 performs information transmission by converting information for transmission provided from the processing unit 51 into an electrical signal and outputting the electrical signal to the communication cable, and performs information reception by acquiring the signal on the communication cable through sampling, and provides the received information to the processing unit 51.

Update Processing

In the case of performing update processing of the ECU 10 of the vehicle 1, a worker in a dealer or a repair shop, for example, performs the task of storing the desired repro data 52a in the storage unit 52 of the repro tool 50. The repro data 52a may be downloaded from a server device or the like to the repro tool 50 by wireless or wired communication, for example, or may be acquired by the repro tool 50 via a recording medium such as a memory card or an optical disc, for example. After storing the repro data 52a in the storage unit 52, the worker connects the communication cable of the repro tool 50 to the OBD connector 5 of the vehicle 1. Authentication processing is thereby performed between the repro tool 50 and the gateway 30 of the vehicle 1, and, in the case where the authentication processing is successful, it becomes possible for the repro tool 50 to communicate with the gateway 30, enabling update processing to be performed.

For example, in the case where the worker performs an operation on the repro tool 50 to start update processing, update processing by the repro tool 50 is started. The update processing unit 51a of the repro tool 50 transmits a request to perform update processing from the OBD communication unit 53 to the gateway 30 of the vehicle 1. In the case where a response from the gateway 30 indicating that update processing is permitted is received to this request by the OBD communication unit 53, the update processing unit 51a of the repro tool 50 starts update processing. The update processing unit 51a reads out the repro data 52a stored in the storage unit 52, and transmits the read repro data 52a to the gateway 30 from the OBD communication unit 53.

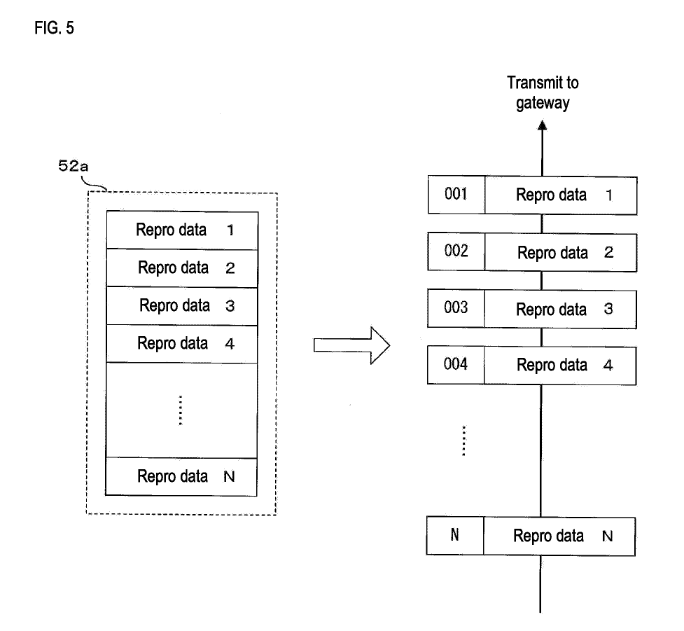

FIG. 5 is a schematic diagram for illustrating transmission of the repro data 52a by the repro tool 50. In the update processing as described above, since the application program 13b stored in the flash memory 13 of the ECU 10 is to be replaced with a new application program, the repro tool 50 needs to transmit this replacement application program to the gateway 30. The repro data 52a that is stored in the storage unit 52 of the repro tool 50 is a collection of data of a predetermined length (e.g., from several bytes to several tens of bytes) into which the replacement application program has been divided. In FIG. 5, the application program is divided into N pieces, which are illustrated as repro data 1 to N. Note that although, in the present embodiment, a configuration in which data into which the application program has been divided in advance is stored in the storage unit 52 of the repro tool 50 is adopted, the present invention is not limited thereto, and the repro tool 50 may perform processing for dividing the application program.

The update processing unit 51a of the repro tool 50 transmits the repro data that was divided (hereinafter, divided data) to the gateway 30 in order, by reading out the divided data from the storage unit 52 in order and providing the read data to the OBD communication unit 53. At this time, the update processing unit 51a assigns sequential order information to the divided data. The assigned sequential order information is stored in the header or the footer, for example, and is transmitted from the repro tool 50 to the gateway 30 together with the divided data. Note that the repro tool 50 may, prior to transmitting the divided data, notify the gateway 30 as to how many pieces of data obtained by dividing the application program for use in updating will be transmitted, that is, the value of N in FIG. 5.

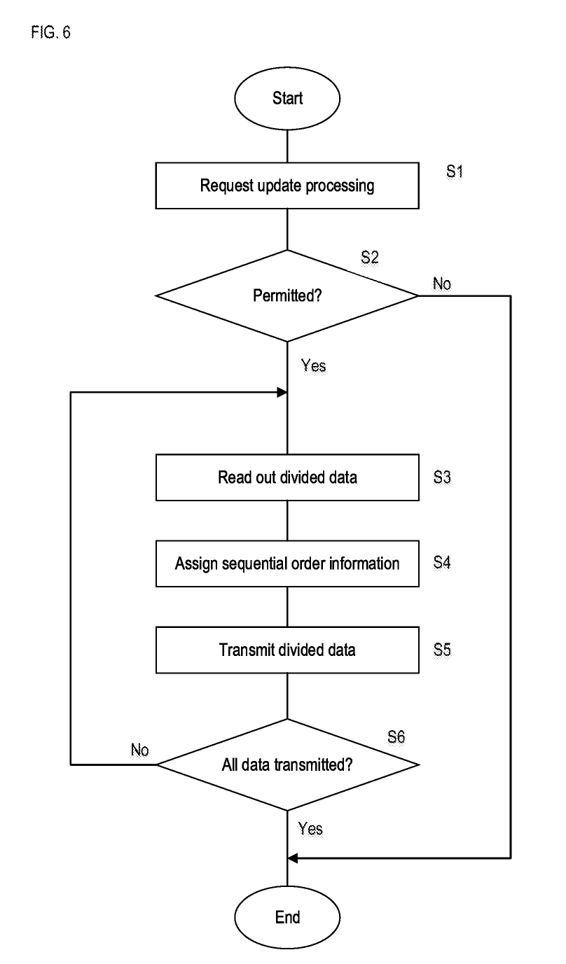

FIG. 6 is a flowchart showing a procedure of transmission processing of the repro data 52a that is performed by the repro tool 50. The update processing unit 51a of the repro tool 50 transmits a request to perform update processing to the gateway 30 from the OBD communication unit 53 (step S1). The update processing unit 51a determines whether a response that is provided from the gateway 30 to this request is a response permitting update processing (step S2). If the response indicates that update processing is not permitted (S2: NO), the update processing unit 51a ends the update processing.

If permission to performs update processing is given from the gateway 30 (S2: YES), the update processing unit 51a reads out one piece of divided data from the storage unit 52 (step S3). The update processing unit 51a assigns sequential order information to the divided data that was read out (step S4). The update processing unit 51a transmits the divided data to the gateway 30, by providing the divided data to the OBD communication unit 53 together with sequential order information (step S5). The update processing unit 51a determines whether transmission of all of the divided data of the repro data 52a stored in the storage unit 52 has ended (step S6). If transmission of the divided data has not ended (S6: NO), the update processing unit 51a returns the processing to step S3, and transmits the next piece of divided data. If transmission of all of the divided data has ended (S6: YES), the update processing unit 51a ends the update processing.

The gateway 30, having received the request for update processing provided from the repro tool 50 via the OBD connector 5, determines whether to permit update processing, based on the state of an ignition switch of the vehicle 1 or the detection results of various sensors, for example, and transmits the determination result to the repro tool 50 as a response. The gateway 30 can be configured to not permit update processing in the case where it is determined that the vehicle 1 is running, and to permit update processing in the case where it is determined that the vehicle 1 is not running, for example.

In the case where a response that permits update processing is transmitted to the repro tool 50 from the gateway 30, the repro tool 50 starts transmission of the divided data of the repro data 52a as described above. The update processing unit 31b of the gateway 30 receives the divided data that is transmitted from the repro tool 50 with the OBD communication unit 35, and stores the divided data that is received in the RAM 34.

Also, the update processing unit 31b of the gateway 30, in the case where the ECU 10 connected to the plurality of communication lines 2a and 2b is to undergo update processing, performs processing for determining the communication state of each of the communication lines 2a and 2b, in parallel with reception processing of the divided data from the repro tool 50. In the present embodiment, the update processing unit 31b calculates the load factor of each of the communication lines 2a and 2b as the communication state, and determines the utilization ratio of the communication lines 2a and 2b that are to be utilized in update processing according to the calculated load factors. The update processing unit 31b checks the time period for which the communication lines 2a and 2b were used (time period taken for a message to be transmitted and received) within a predetermined time period, and calculates the ratio of the usage time period to the predetermined time period as the load factor.

For example, assume that the calculation result of the update processing unit 31b is a load factor of 20% for the communication line 2a and a load factor of 40% for the communication line 2b. Also, assume that the upper limit of the load factor for the communication lines 2a and 2b is set to 50%. In this case, the update processing unit 31b judges that the margin of the communication line 2a is 50%-20%=30% and the margin of the communication line 2b is 50%-40%=10%. From these results, the update processing unit 31b transmits the plurality of divided data stored in the RAM 14 so as to be distributed at a ratio of communication line 2a:communication line 2b=3:1. That is, the update processing unit 31b, in the case where four pieces of divided data are stored in the RAM 14, transmits three pieces over the communication line 2a, and transmits one piece over the communication line 2b.

In the case where the load factor of the communication line 2a is X %, the load factor of the communication line 2b is Y %, and the upper limit of the load factor of each of the communication lines 2a and 2b is set to Q %, the update processing unit 31b distributes the divided data at a ratio of communication line 2a:communication line 2b=(Q−X):(Q−Y). Also, for example, in the case where the ECU to be updated is connected to the three communication lines 2a to 2c, the load factor of the communication line 2a is X %, the load factor of the communication line 2b is Y %, the load factor of the communication line 2c is Z %, and the upper limit of the load factor of each of the communication lines 2a to 2c is set to Q %, the update processing unit 31b need only distribute the divided data at a ratio of communication line 2a:communication line 2b:communication line 2c=(Q−X):(Q−Y):(Q−Z). Since this similarly applies in the case where the ECU to be updated is connected to four or more communication lines, description will be omitted.

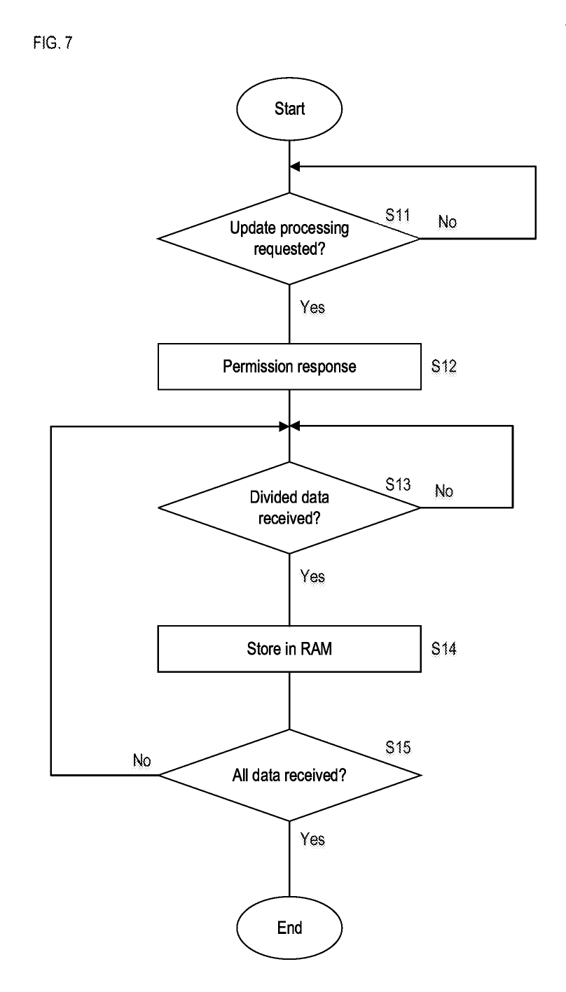

FIG. 7 is a flowchart showing a procedure of reception processing of the repro data 52a that is performed by the gateway 30. The update processing unit 31b of the gateway 30 determines whether a request to perform update processing has been received from the repro tool 50 by the OBD communication unit 35 (step S11). If a request for update processing has not been received (S11: NO), the update processing unit 31b waits until a request is received. If a request for update processing has been received (S11: YES), the update processing unit 31b transmits a response indicating that update processing is permitted to the repro tool 50 from the OBD communication unit 35 (step S12). Note that, in this flowchart, the processing procedure in the case where update processing is not permitted is omitted.

Thereafter, the update processing unit 31b determines whether divided data of the repro data 52a has been received from the repro tool 50 by the OBD communication unit 35 (step S13). If divided data has not been received (S13: NO), the update processing unit 31b waits until divided data is received. If divided data has been received (S13: YES), the update processing unit 31b stores the divided data that was received in the RAM 34 (together with the sequential order information attached to this divided data) (step S14). The update processing unit 31b determines whether all of the divided data of the repro data 52a has been received (step S15). If all of the divided data has not been received (S15: NO), the update processing unit 31b returns the processing to step S13, and continues reception of divided data. If all of the divided data has been received (S15: YES), the update processing unit 31b ends the reception processing.

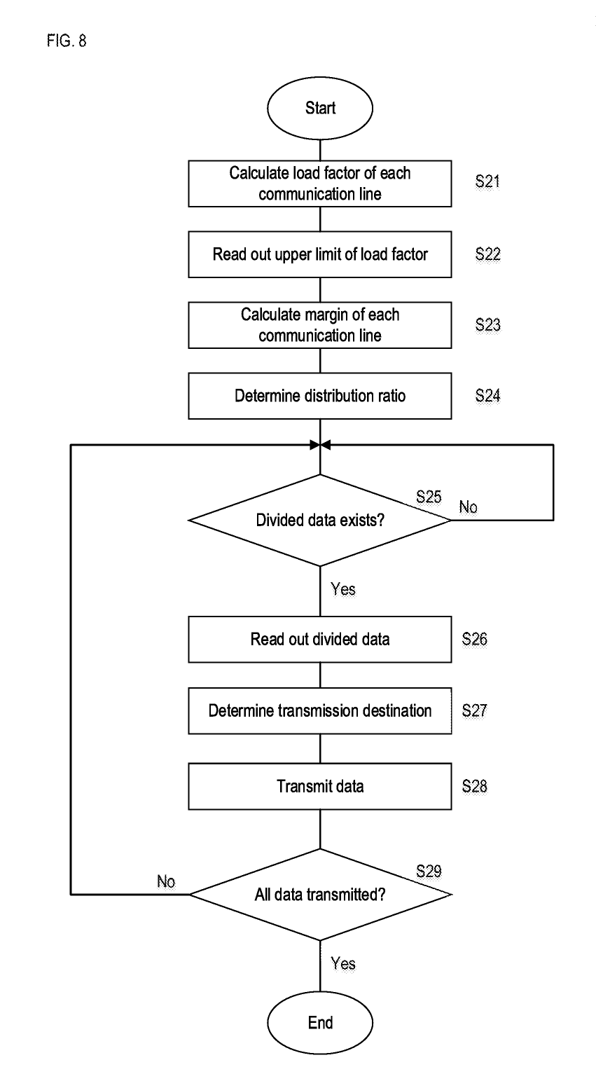

FIG. 8 is a flowchart showing a procedure of transmission processing of the repro data 52a that is performed by the gateway 30, with this processing being performed in parallel with the abovementioned reception processing, after giving a permission response to the update processing request from the repro tool 50. The update processing unit 31b of the gateway 30 calculates the load factor of each of the communication lines 2a and 2b, by checking the time period for which communication was performed within a predetermined time period with regard to the plurality of communication lines 2a and 2b to which the ECU 10 to be updated is connected (step S21). The update processing unit 31b reads out the upper limit of the load factor determined in advance (step S22). The update processing unit 31b calculates the margin of each of the communication lines 2a and 2b, based on the load factors calculated at step S21 and the upper limit read out at step S22 (step S23). The update processing unit 31b determines the distribution ratio of the divided data for the plurality of communication lines 2a and 2b, based on the margin calculated for each of the communication lines 2a and 2b (step S24).

The update processing unit 31b determines whether divided data is stored in the RAM 34 (step S25). If divided data is not stored (S25: NO), the update processing unit 31b waits until divided data is received from the repro tool 50 and stored in the RAM 34. If divided data is stored (S25: YES), the update processing unit 31b reads out one piece of divided data from the RAM 34 (step S26). Note that, at this time, the update processing unit 31b preferably checks the sequential order information attached to the divided data, and reads out the divided data that is earliest in the order. The update processing unit 31b determines one of the communication lines 2a and 2b to be the transmission destination of the divided data this time, out of the plurality of communication lines 2a and 2b, based on the distribution ratio determined at step S24 (step S27). The update processing unit 31b transmits the divided data read out at step S26 over the communication line 2a or 2b determined at step S27 (step S28).

The update processing unit 31b determines whether all of the divided data of the repro data 52a that is to be transmitted to the ECU 10 has been transmitted (step S29). If all of the divided data has not been transmitted (S29: NO), the update processing unit 31b returns the processing to step S25, and continues transmission of divided data. If all of the divided data has been transmitted (S29: YES), the update processing unit 31b ends the transmission processing.

The divided data of the repro data 52a transmitted by the gateway 30 via the plurality of communication lines 2a and 2b is received by the ECU 10 connected to these communication lines 2a and 2b. The ECU 10, having received divided data, stores the divided data that was received in the RAM 14. Note that even in the case where the gateway 30 transmits divided data in the order that is shown in sequential order information, in the ECU 10 that receives the divided data via the plurality of communication lines 2a and 2b, the divided data is not necessarily received in the order shown in the sequential order information.

The update processing unit 11a of the ECU 10 is able to perform update processing by performing processing for restoring the repro data 52a after all of the divided data has been received, and replacing the application program 13b stored in the flash memory 13 with the application program provided as the repro data 52a. Note that the update processing unit 11a may partially replace the application program 13b using the divided data that has been received, even prior to all of the divided data being received, and is thereby able to speed up the update processing.

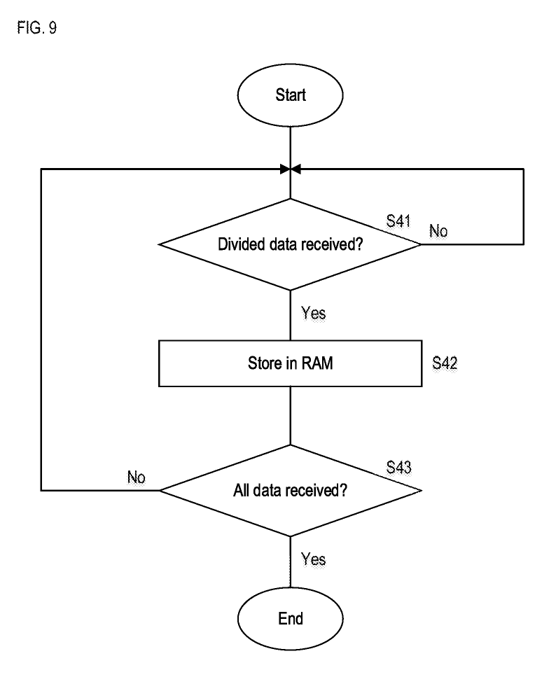

FIG. 9 is a flowchart showing a procedure of reception processing of the repro data 52a that is performed by the ECU 10. The update processing unit 11a of the ECU 10 determines whether divided data of the repro data 52a from the gateway 30 has been received by either of the communication units 12a and 12b (step S41). If neither of the communication units 12a and 12b has received divided data (S41: NO), the update processing unit 11a waits until divided data is received. If divided data has been received (S41: YES), the update processing unit 11a stores the received data in the RAM 14 (step S42). The update processing unit 11a determines whether all of the divided data of the repro data 52a has been received (step S43). If all of the divided data has not been received (S43: NO), the update processing unit 11a returns the processing to step S41, and continues reception of divided data. If all of the divided data has been received (S43: YES), the update processing unit 11a ends the reception processing.

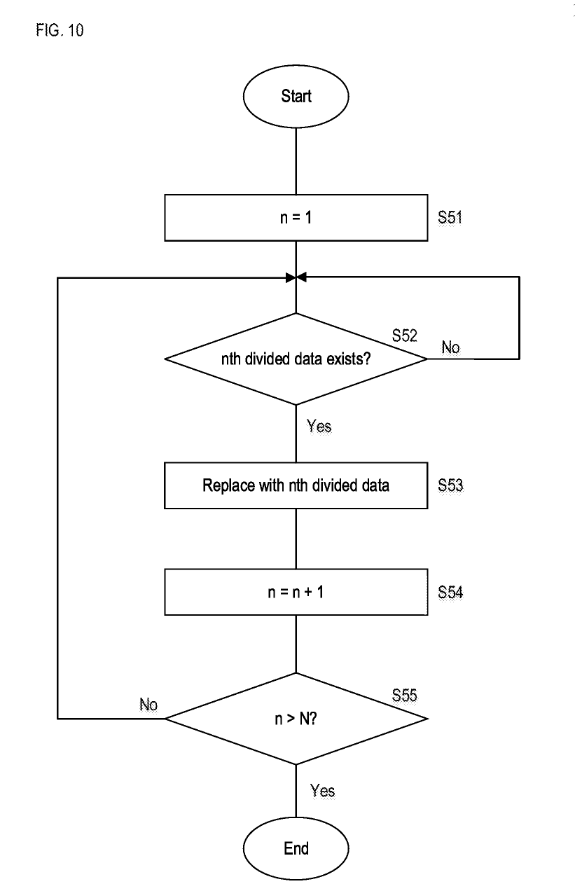

FIG. 10 is a flowchart showing a procedure of update processing of the application program 13b that is performed by the ECU 10. Note that, in this processing, a variable n that stores the sequential order information of divided data that is to be written is used, and this variable can be realized using a register within the processing unit 11, for example. The update processing unit 11a of the ECU 10 first initializes the value of the variable n to 1 (step S51). Next, the update processing unit 11a determines whether divided data to which sequential order information indicating that the divided data is the nth piece is attached is stored in the RAM 14 (step S52). If the nth divided data is not stored (S52: NO), the update processing unit 11a waits until the nth divided data is stored in the RAM 14.

If the nth divided data is stored in the RAM 14 (S52: YES), the update processing unit 11a performs processing for replacing part of the application program 13b stored in the flash memory 13 with the nth divided data stored in the RAM 14 (step S53). At this time, the update processing unit 11a is able to perform the replacement by erasing the corresponding section of the application program 13b from the flash memory 13, and writing the nth divided data to the section that was erased. The update processing unit 11a may, however, initially erase the entire application program 13b, and write the nth divided data to the free area of the flash memory 13.

After writing of the divided data to the flash memory 13 is completed, the update processing unit 11a adds 1 to the value of the variable n (step S54). The update processing unit 11a determines whether the value of the variable n exceeds the number N of divided data (step S55). If the value of the variable n does not exceed the number N of divided data (S55: NO), the update processing unit 11a returns the processing to step S52, and continues writing of divided data. If the value of the variable n exceeds the number N of divided data (S55: YES), the update processing unit 11a ends the update processing.

### SUMMARY

The updating system according to the present embodiment having the above configuration performs update processing of the ECU 10, by the gateway 30 connected to the two communication lines 2a and 2b transmitting the repro data 52a for use in updating to the ECU 10 connected to these two communication lines 2a and 2b. The gateway 30 stores a plurality of divided data into which the repro data 52a has been divided in the RAM 34. The gateway 30 determines the communication state of each of the communication lines 2a and 2b, appropriately distributes the plurality of divided data to the plurality of communication lines 2a and 2b according to the determined communication states, and transmits the plurality of divided data to the ECU 10 via the plurality of communication lines 2a and 2b. It thereby becomes possible for the gateway 30 to efficiently perform high speed transmission of the plurality of divided data to the ECU 10, by effectively utilizing the plurality of communication lines 2a and 2b.

Also, the gateway 30 calculates the load factor of each communication line, with regard to the plurality of communication lines 2a and 2b to which the ECU 10 to be updated is connected. The gateway 30 is able to perform distribution of the divided data that depends on the determined load factors, such as distributing the divided data preferentially to the communication line 2a or 2b having a low load, for example. The gateway 30 is thereby able to efficiently utilize the plurality of communication lines 2a and 2b.

Also, in the updating system according to the present embodiment, the repro tool 50, which is separate from the gateway 30, stores the divided data of the repro data 52a in the storage unit 52. When performing update processing, the divided data of the repro data 52a is transmitted from the repro tool 50 to the gateway 30, and this divided data is provided to the ECU 10 from the gateway 30. The gateway 30 thereby does not need to store the repro data 52a, and need only temporarily store the divided data of the repro data 52a provided from the repro tool 50 in the RAM 34.

Also, the repro tool 50 attaches, to the divided data into which the repro data 52a has been divided, sequential order information for restoring the divided data, and transmits the resultant data to the gateway 30. The gateway 30, in the case where divided data is received from the repro tool 50, stores the divided data in the RAM 34 together with the sequential order information. Also, the gateway 30 transmits the divided data to which the sequential order information is attached to the ECU 10. The ECU 10, having received the divided data of the repro data 52a via the plurality of communication lines 2a and 2b, is thereby able to restore the original repro data 52a from the plurality of divided data, even in the case where the order of the divided data differs from the received order.

Also, the ECU 10 has the RAM 14 that temporarily stores the divided data of the repro data 52a received from the gateway 30 via the plurality of communication lines 2a and 2b, separately from the flash memory 13 that stores the application program 13b that is used in processing that the ECU 10 itself performs. The ECU 10 performs processing for updating the application program 13b stored in the flash memory 13 using the divided data stored in the RAM 14, based on the sequential order information attached to the divided data. The ECU 10 is thereby able to reliably perform update processing of the application program 13b, using divided data that is received in random order via the plurality of communication lines 2a and 2b.

Note that although, in the present embodiment, a configuration is adopted in which the gateway 30 transmits the divided data of the repro data 52a to the ECU 10 to be updated, the present invention is not limited thereto. For example, a configuration in which the other ECUs 3a to 3d transmit the divided data of the repro data 52a to the ECU 10 may be adopted, or, furthermore, a configuration in which another device such as a car navigation device mounted in the vehicle 1 transmits the divided data to the ECU 10 may be adopted. Also, although the ECU 10 is given as the device to be updated, the present invention is not limited thereto, and various devices other than the ECU 10 mounted in the vehicle 1 can be subjected to update processing. Also, although the repro tool 50 is given as the device that transmits the divided data of the repro data 52a to the gateway 30, the present invention is not limited thereto, and a general-purpose portable device such as a laptop PC, a smartphone or a tablet terminal, for example, may be used, or even a stationary device that is not portable installed in a dealer, a repair shop or the like of the vehicle 1.

Also, although, in the present embodiment, a configuration is adopted in which the application program 13b stored in the flash memory 13 of the ECU 10 is updated, the present invention is not limited thereto. For example, a configuration in which data stored in the flash memory 13 of the ECU 10, such as setting values related to operations of the ECU 10, for example, is updated may be adopted, or a configuration in which both the application program 13b and data are updated may be adopted. Also, although a configuration is adopted in which communication via the two communication lines 2a and 2b is performed between the gateway 30 and the ECU 10, the present invention is not limited thereto, and a configuration in which communication is performed via three or more communication lines may also be adopted.

Also, although a configuration is adopted in which the update processing unit 31b of the gateway 30 calculates the load factor of each of the communication lines 2a and 2b, and distributes the divided data to the plurality of communication lines 2a and 2b based on these load factors, the present invention is not limited thereto. A configuration may be adopted in which the update processing unit 31b distributes the divided data based on a communication state other than the load factor, such as, for example, checking the priority attached to messages that are transmitted to the communication lines 2a and 2b, and lowering the distribution ratio of divided data for the communication line 2a or 2b to which messages having a high priority are often transmitted.

Also, although, in the present embodiment, a configuration is adopted in which update processing is performed with a communication system mounted in the vehicle 1, the present invention is not limited thereto, and a configuration in which update processing is performed in a communication system other than an in-vehicle communication system may also be adopted.

Also, although a configuration is adopted in which the gateway 30 and the repro tool 50 communicate by connecting a communication cable to the OBD connector 5 of the vehicle 1, the present invention is not limited thereto. The connection between the repro tool 50 and the vehicle 1 may be based on a standard other than OBD. Furthermore, as shown in the following variations, a configuration may be adopted in which the gateway 30 and the repro tool 50 are wirelessly connected rather than being connected via a cable.

Variations

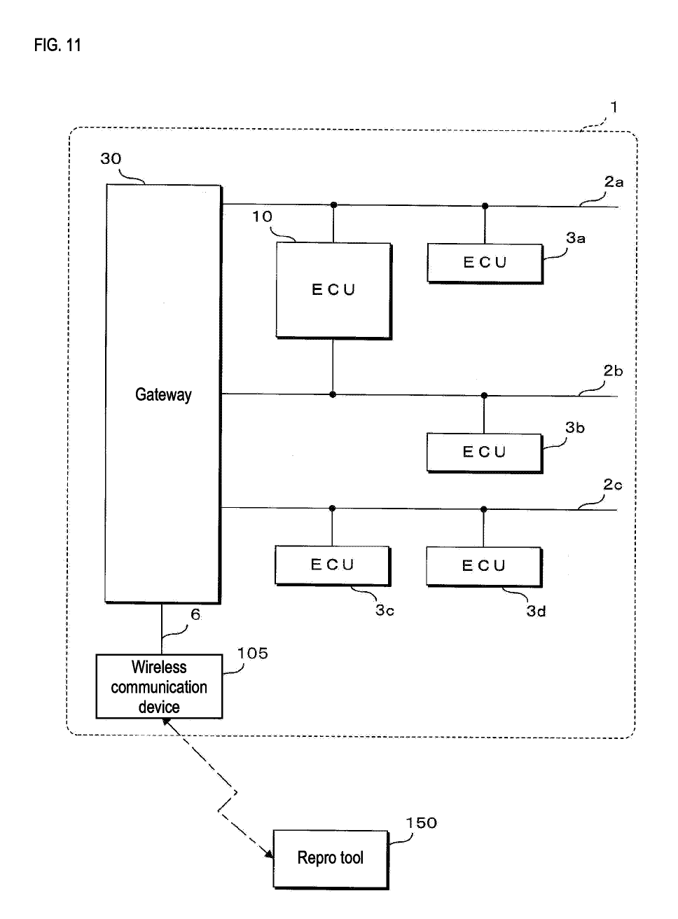

FIG. 11 is a schematic diagram showing an exemplary configuration of an updating system according to a variation. In the updating system according to the variation, a gateway 30 is connected to a wireless communication device 105 via a communication line 6. The wireless communication device 105 is able to wirelessly communicate with a repro tool 150, via a wireless network such as a mobile phone communication network or a wireless LAN (Local Area Network), for example. Although having substantially the same configuration as the repro tool 50 shown in FIG. 4, the repro tool 150 according to the variation is provided with a wireless communication unit instead of the OBD communication unit 53, and is able to communicate wirelessly with the gateway 30 of the vehicle 1 via a wireless network. In the updating system according to the variation, the repro tool 50 is thereby able to transmit the divided data of the repro data 52a to the wireless communication device 105 of the vehicle 1 by wireless communication, and the wireless communication device 105 is able to transmit the divided data that is received to the gateway 30.

Note that although, in the updating system according to the variation, a configuration is adopted in which the gateway 30 wirelessly communicates with the repro tool 150 utilizing the wireless communication device 105, the wireless communication partner is not limited to the repro tool 150. For example, the gateway 30 may acquire the repro data 52a by communicating directly with a server device or the like that distributes the repro data 52a, without passing through the repro tool 150.

1. An in-vehicle updating device configured to be connected to an in-vehicle communication device via at least two communication lines and to perform processing for updating a program or data stored in a storage unit of the in-vehicle communication device, comprising:
a storage unit configured to store a plurality of divided data for use in updating into which a program or data for use in updating that is to be transmitted to the in-vehicle communication device has been divided;
a communication state determination unit configured to determine a communication state of each of the communication lines; and
a transmission processing unit configured to perform processing for distributively transmitting the plurality of divided data for use in updating stored in the storage unit to the in-vehicle communication device via the at least two communication lines, according to a determination result of the communication state determination unit.

2. The in-vehicle updating device according to claim 1,
wherein the communication state determination unit determines a communication load of each of the communication lines, and
the transmission processing unit distributes the plurality of divided data for use in updating to the at least two communication lines according to the communication loads.

3. The in-vehicle updating device according to claim 1, further comprising:
a communication unit configured to communicate with a storage device storing the divided data for use in updating; and
a storage processing unit configured to perform processing for storing the divided data for use in updating received from the storage device via the communication unit in the storage unit.

4. An updating system comprising an in-vehicle communication device that is connected to at least two communication lines and has a first storage unit configured to store a program or data, and an in-vehicle updating device that is connected to the in-vehicle communication device via the at least two communication lines and performs processing for updating the program or data stored in the storage unit of the in-vehicle communication device,
the in-vehicle updating device including:
a storage unit configured to store a plurality of divided data for use in updating into which a program or data for use in updating that is to be transmitted to the in-vehicle communication device has been divided;
a communication state determination unit configured to determine a communication state of each of the communication lines; and
a transmission processing unit configured to perform processing for distributively transmitting the plurality of divided data for use in updating stored in the storage unit to the in-vehicle communication device via the at least two communication lines, according to a determination result of the communication state determination unit.

5. The updating system according to claim 4, further comprising:
a storage device storing the divided data for use in updating,
wherein the in-vehicle updating device further includes:
a communication unit configured to communicate with the storage device storing the divided data for use in updating; and
a storage processing unit configured to perform processing for storing the divided data for use in updating received from the storage device via the communication unit in the storage unit.

6. The updating system according to claim 5,
wherein the storage device attaches sequential order information to the divided data for use in updating, and transmits the divided data for use in updating to which the sequential order information is attached to the in-vehicle updating device, and
the storage processing unit of the in-vehicle updating device stores the divided data for use in updating to which the sequential order information is attached in the storage unit.

7. The updating system according to claim 6,
wherein the in-vehicle communication device includes:
a second storage unit configured to temporarily store the divided data for use in updating received from the in-vehicle updating device via the at least two communication lines; and
an update processing unit configured to perform processing for updating the program or data stored in the first storage unit, using the divided data for use in updating stored in the second storage unit, based on the sequential order information attached to the divided data for use in updating stored in the second storage unit.

8. An update processing program for causing an in-vehicle updating device configured to be connected to an in-vehicle communication device via at least two communication lines and to perform processing for updating a program or data stored in a storage unit of the in-vehicle communication device to operate as:
a storage processing unit configured to store a plurality of divided data for use in updating into which a program or data for use in updating that is to be transmitted to the in-vehicle communication device has been divided in a storage unit;
a communication state determination unit configured to determine a communication state of each of the communication lines; and
a transmission processing unit configured to perform processing for distributively transmitting the plurality of divided data for use in updating stored in the storage unit to the in-vehicle communication device via the at least two communication lines, according to a determination result of the communication state determination unit.

9. The in-vehicle updating device according to claim 2, further comprising:
a communication unit configured to communicate with a storage device storing the divided data for use in updating; and
a storage processing unit configured to perform processing for storing the divided data for use in updating received from the storage device via the communication unit in the storage unit.
